(19) United States
(12) Patent Application Publication
(10) Pub. No.: US 2020/0283162 A1
(43) Pub. Date: Sep. 10, 2020

(54) MOTOR CONTROL SYSTEM AND UNMANNED AERIAL VEHICLE

(71) Applicant: AUTEL ROBOTICS CO., LTD., Shenzhen (CN)

(72) Inventors: Yidong CHEN, Shenzhen (CN); Zhuanpeng CHENG, Shenzhen (CN)

(21) Appl. No.: 16/739,485

(22) Filed: Jan. 10, 2020

Related U.S. Application Data
(63) Continuation of application No. PCT/CN2018/079007, filed on Mar. 14, 2018.

(30) Foreign Application Priority Data
Jul. 11, 2017 (CN) 201710561100.5

(51) Int. Cl. B64D 31/00; B64D 27/24; B64C 39/02

(52) U.S. Cl. CPC B64D 31/00; B64D 27/24; B64C 2201/108; B64C 2201/042; B64C 39/024

(57) ABSTRACT

The present application relates to the field of unmanned aerial vehicle (UAV) technologies, and provides a motor control system and a UAV. The motor control system includes a control unit, a first inverter electrically connected to the control unit, a second inverter electrically connected to the control unit, a first motor electrically connected to the first inverter and a second motor electrically connected to the second inverter. According to the foregoing manner, two inverters in the motor control system are electrically connected to one control unit. Therefore, the control unit can control running of two motors, thereby reducing the volume of a hardware circuit board having the motor control system and reducing the weight.

This application is a continuation of International Patent Application No. PCT/CN2018/079007 filed on Mar. 14, 2018, which claims priority to Chinese Patent Application No. 201710561100.5 filed on Jul. 11, 2017, both of which are incorporated by reference in their entireties.

### BACKGROUND

### Technical Field

The present application relates to the field of unmanned aerial vehicle (UAV) technologies, and in particular, to a motor control system and a UAV having the same.

### Related Art

An unmanned aerial vehicle (UAV) is a type of new concept equipment in rapid development, which has advantages of high flexibility, fast response, pilotless driving and low operation requirements. The UAV can implement functions of real-time video transmission and high-risk area detection by carrying a plurality of types of sensors or camera devices, and is a powerful supplement of satellite remote sensing and traditional aerial remote sensing. Currently, the application range of the UAV has been expanded to three fields: military, scientific research and civil use, and in particular, to the fields such as power communication, meteorology, agriculture, ocean, exploration, photography, disaster prevention and reduction, crop yield estimation, drug and smuggling prevention, border patrol, public security and anti-terrorism.

In the process of implementing the present application, inventors found that the prior art has at least the following problems: Currently, a four-rotor UAV generally has an excessive volume of a hardware circuit board and a heavy weight. This is not only conducive to the miniaturization design of the UAV, and restricts the flexibility of the structure design of the UAV, but also affects and limits the endurance of the UAV.

### SUMMARY

To resolve the foregoing technical problem, embodiments of the present application provide a motor control system having a small size, a compact structure and a light weight, and an unmanned aerial vehicle (UAV) having the motor control system.

To resolve the foregoing technical problem, the embodiments of the present application provide the following technical solutions.

A motor control system includes a control unit, a first inverter electrically connected to the control unit, a second inverter electrically connected to the control unit, a first motor electrically connected to the first inverter and a second motor electrically connected to the second inverter, the first inverter being connected in parallel to the second inverter.

The control unit is configured to output a control signal to the first inverter and the second inverter and to respectively control, by using an alternating signal output by the first inverter and the second inverter, a running state of the first motor and the second motor that are electrically connected thereto.

In some embodiments, the first inverter includes at least one first power unit electrically connected to the first motor, the control unit is electrically connected to the at least one first power unit, and the control unit outputs the control signal to the at least one first power unit and controls the running state of the first motor by using an alternating signal output by the first power unit.

The second inverter includes at least one second power unit electrically connected to the second motor, the control unit is electrically connected to the at least one second power unit, and the control unit outputs the control signal to the at least one second power unit and controls the running state of the second motor by using an alternating signal output by the second power unit.

In some embodiments, the first power unit includes a first power subunit, a second power subunit and a third power subunit that are connected in parallel to each other, and the second power unit includes a fourth power subunit, a fifth power subunit and a sixth power subunit that are connected in parallel to each other.

In some embodiments, both the first power unit and the second power unit include a drive circuit configured to receive the control signal, a first power element electrically connected to the drive circuit and a second power element electrically connected to the drive circuit, the first power element being connected in series to the second power element.

In some embodiments, both the first power element and the second power element are MOS transistors.

In some embodiments, the motor control system further includes a first sampling circuit configured to acquire a three-phase voltage of the first motor and a second sampling circuit configured to acquire a three-phase voltage of the second motor, where the first sampling circuit is electrically connected between the first inverter and the first motor, and the second sampling circuit is electrically connected between the second inverter and the second motor.

In some embodiments, the first sampling circuit includes a first sampling resistor and a first operational amplifier circuit connected in parallel to the first sampling resistor; and the second sampling circuit includes a second sampling resistor and a second operational amplifier circuit connected in parallel to the second sampling resistor.

In some embodiments, the control unit is an MCU.

To resolve the foregoing technical problem, the embodiments of the present application further provide the following technical solution.

A UAV includes a body, an arm connected to the body and the foregoing motor control system, a first motor and a second motor being disposed on the arm.

In some embodiments, the first motor and the second motor are disposed diagonally.

Compared with the prior art, the motor control system of the embodiments of the present application includes a first inverter, a second inverter and a control unit. The control unit is electrically connected to the first inverter and the second inverter respectively, the first inverter is electrically connected to the first motor, and the second inverter is electrically connected to the second motor. Two inverters in the motor control system are electrically connected to one control unit, so that the control unit can control running of two motors, thereby reducing the volume of a hardware circuit board having the motor control system and reducing the weight.

### BRIEF DESCRIPTION OF THE DRAWINGS

One or more embodiments are described by way of example with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a simplified schematic diagram of functional modules of a motor control system according to an embodiment of the present application;

FIG. 2 is a schematic structural diagram of the motor control system shown in FIG. 1;

FIG. 3 is a schematic structural diagram of a control unit in the motor control system shown in FIG. 2;

FIG. 4 is a schematic diagram of functional modules of a motor control system applied to an unmanned aerial vehicle (UAV) according to an embodiment of the present application; and

FIG. 5 is a schematic structural diagram of a motor control system applied to a UAV according to an embodiment of the present application.

### DETAILED DESCRIPTION

For ease of understanding the present application, the present application is described in further detail below with reference to the accompanying drawings and specific implementations. It should be noted that when an element is described as being “fixed” on another element, the element may be directly on the another element, or one or more intermediate elements may exist therebetween. When an element is described as being “electrically connected” to another element, the element may be directly connected to the another element, or one or more intermediate elements may exist therebetween. A direction or location relationship indicated by the term “on”, “under”, “inner”, “outer”, “bottom”, or the like used in this specification is a direction or location relationship shown based on the accompanying drawings, and is used only for ease of describing the present application and simplifying the description, but is not intended to indicate or imply that a mentioned apparatus or element needs to have a particular direction and is constructed and operated in the particular direction. Therefore, the direction or location relationship cannot be understood as a limitation to the present application. In addition, the terms such as “first”, “second” and “third” are merely intended to describe the objective and shall not be understood as an indication or implication of relative importance.

Unless otherwise defined, meanings of all technical and scientific terms used in this specification are the same as meanings usually understood by persons skilled in the technical field to which the present application belongs. The terms used in this specification of the present application are merely intended to describe specific implementations rather than limit the present application. A term “and/or” used in this specification includes any or all combinations of one or more related listed items.

In addition, technical features in different implementations of the present application described below may be combined with each other provided that there is no conflict with each other.

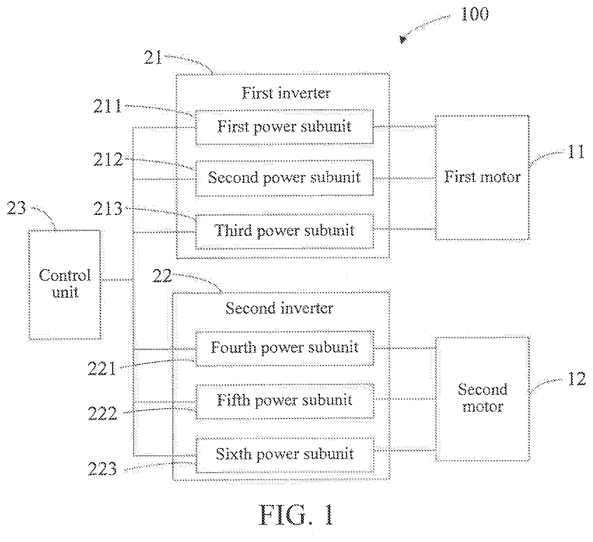

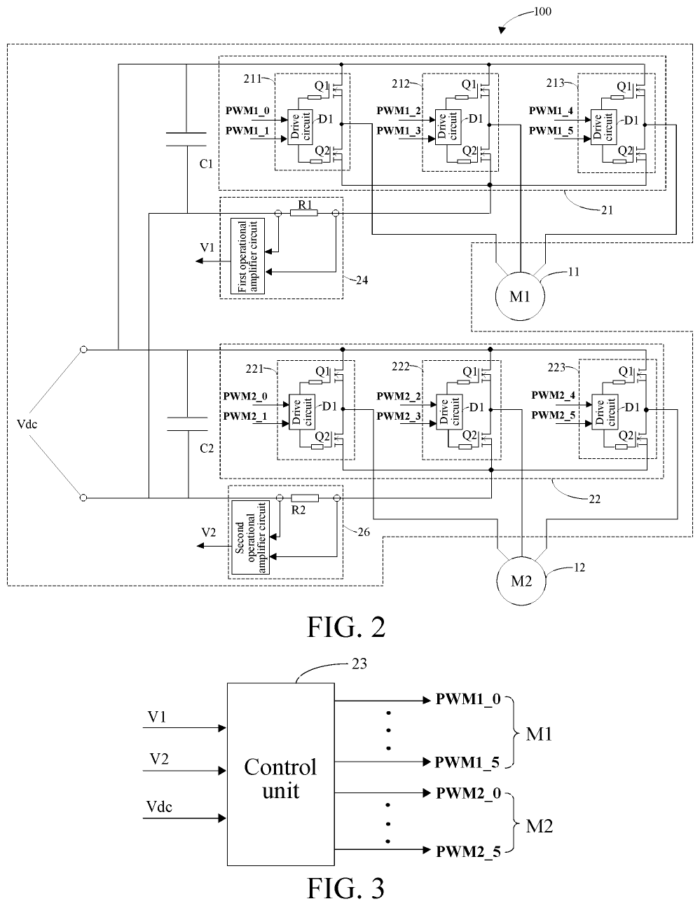

Referring to FIG. 1 and FIG. 2, the embodiments of the present application provides a motor control system 100, including a control unit 23, a first inverter 21 electrically connected to the control unit 23, a first motor 11 electrically connected to the first inverter 21, and a second inverter 22 and a second motor 12 electrically connected to the second inverter 22. The first inverter 21 is connected in parallel to the second inverter 22. The control unit 23 is configured to output a control signal to the first inverter 21 and the second inverter 22 and to respectively control, by using an alternating signal output by the first inverter 21 and the second inverter 22, a running state of the first motor 11 and the second motor 12 that are electrically connected thereto. In this embodiment, the control unit 23, the first inverter 21 and the second inverter 22 are all integrated on the same circuit board 20. Two inverters (namely, the first inverter 21 and the second inverter 22) in the motor control system 100 are electrically connected to one control unit 23, so that the control unit 23 can control running of two motors (namely, the first motor 11 and the second motor 12), thereby reducing the volume of a hardware circuit board having the motor control system and reducing the weight.

In this embodiment, the control unit 23 is an MCU.

The first inverter 21 includes at least one first power unit 211, 212, 213 electrically connected to the first motor 11. The control unit 23 is electrically connected to the at least one first power unit 211, 212, 213. The control unit 23 outputs the control signal to the at least one first power unit 211, 212, 213 and controls the running state of the first motor 11 by using an alternating signal output by the first power unit 211, 212, 213. In this embodiment, the first power unit 211, 212, 213 includes a first power subunit 211, a second power subunit 212 and a third power subunit 213 that are connected in parallel. The first power subunit 211, the second power subunit 212 and the third power subunit 213 are all electrically connected to the first motor 11. The first power subunit 211, the second power subunit 212 and the third power subunit 213 receive the control signal from the control unit 23, so as to control the running state of the first motor 11.

The second inverter 22 includes at least one second power unit 221, 222,223 electrically connected to the second motor 12. The control unit 23 is electrically connected to the at least one second power unit 221, 222, 223. The control unit 23 outputs the control signal to the at least one second power unit 221, 222, 223 and controls the running state of the first motor 12 by using an alternating signal output by the second power unit 221, 222, 223. In this embodiment, the second power unit 221, 222, 223 includes a fourth power subunit 221, a fifth power subunit 222 and a sixth power subunit 223 that are connected in parallel. The fourth power subunit 221, the fifth power subunit 222 and the sixth power subunit 223 are all electrically connected to the second motor 12. The fourth power subunit 221, the fifth power subunit 222 and the sixth power subunit 223 receive the control signal from the control unit 23, so as to control the running state of the second motor 12.

In this embodiment, the first power subunit 211, the second power subunit 212, the third power subunit 213, the fourth power subunit 221, the fifth power subunit 222 and the sixth power subunit 223 are all include a drive circuit D1, a first power element Q1 and a second power element Q2. The drive circuit D1 is electrically connected to the first power element Q1 and the second power element Q2 respectively. This design has advantages: The switching speed of the drive circuit is very fast, the driving capability is strong, and the turn-off speed of two power elements is fast.

Generally, a quantity of power units is determined by a quantity of phases of the motor. In this embodiment, both the first motor 11 and the second motor 12 adopted are a three-phase motor. Therefore, both the first inverter 21 and the second inverter 22 include three power units. The three-phase motor has many advantages such as a simple structure, reliable running, a light weight, and low price. In other embodiments, the first motor and the second motor may alternatively be a single-phase motor. Therefore, the first inverter and the second inverter include only one power unit. The single-phase motor has many advantages such as simple wiring, long service life, and quick start.

It can be understood that the first inverter 21 and the second inverter 22 as well as the first motor 11 and the second motor 22 may be completely the same in structures and functions, and only for more clearly describing a connection relationship of the two inverters and the two motors, the “first” and “second” are named respectively.

It can be understood that in an embodiment of the present application, both the first power element Q1 and the second power element Q2 are MOS transistors. In other embodiments, the first power element Q1 and the second power element Q2 may also be an insulated gate bipolar transistor (IGBT) or a thyristor.

The drive circuit D1 is provided with a signal receiving end for receiving the control signal sent by the control unit 23, so as to turn on or turn off the first power element Q1 or the second power element Q2. The first power element Q1 and the second power element Q2 are not turned on or turned off at the same time, thereby forming the alternating signal used for controlling the motor.

The motor control system 100 further includes a first sampling circuit 24 configured to acquire a three-phase voltage V1 of the first motor 11 and a second sampling circuit 26 configured to acquire a three-phase voltage V2 of the second motor 12. As a preferred embodiment, the first sampling circuit 24 includes a first sampling resistor R1 and a first operational amplifier circuit connected in parallel to the first sampling resistor. The second sampling circuit 26 includes a second sampling resistor R2 and a second operational amplifier circuit connected in parallel to the second sampling resistor. The first sampling resistor R1 is electrically connected to the second power element Q2 in the first power subunit 211, the second power subunit 212 and the third power subunit 213 respectively. The second sampling resistor R2 is electrically connected to the second power element Q2 in the fourth power subunit 221, the fifth power subunit 222 and the sixth power subunit 223 respectively. The first sampling circuit 24 and the second sampling circuit 26 may feed back the three-phase voltage V1 of the first motor 11 and the three-phase voltage V2 of the second motor 12 that are acquired to the control unit 23. The control unit 23 may obtain the running state of the first motor 11 and the second motor 12 according to the received three-phase voltage V1 and the three-phase voltage V2. The control unit 23 may alternatively adjust the running state of the first motor 11 and the second motor 12 according to the received three-phase voltage V1 and the three-phase voltage V2, so that the control unit 23 controls the running state of the first motor 11 and the second motor 12 more precisely. In an embodiment of the present application, the control signal is obtained through vector operation by inputting the three-phase voltage V1 acquired by the first sampling circuit 24, the three-phase voltage V2 acquired by the second sampling circuit 26 and a DC-side voltage Vdc of the motor control system to the control unit 23. In this embodiment, the control signal output by the control unit 23 includes first pulse-width modulation (PWM) signals (PWM1_0, PWM1_1, PWM1_2, PWM1_3, PWM1_4 and PWM1_5) for controlling the first motor 11 and second PWM signals (PWM2_0, PWM2_1, PWM2_2, PWM2_3, PWM2_4 and PWM2_5) used for controlling the second motor 12.

Each power unit is controlled by two PWM waves, and in other possible embodiments, the power unit may alternatively be controlled by one PWM signal. Specifically, the first PWM signals PWM1_0 and the PWM1_1 are input to the drive circuit D1 in the first power subunit 211, so as to control the turn-on or turn-off of the first power element Q1 and the second power element Q2 in the first power subunit 211. The first PWM signals PWM1_2 and the PWM1_3 are input to the drive circuit D1 in the second power subunit 212, so as to control the turn-on or turn-off of the first power element Q1 and the second power element Q2 in the second power subunit 212. The first PWM signals PWM1_4 and the PWM1_5 are input to the drive circuit D1 in the third power subunit 213, so as to control the turn-on or turn-off of the first power element Q1 and the second power element Q2 in the third power subunit 213.

The second PWM signals PWM2_0 and the PWM2_1 are input to the drive circuit D1 in the fourth power subunit 221, so as to control the turn-on or turn-off of the first power element Q1 and the second power element Q2 in the fourth power subunit 221. The second PWM signals PWM2_2 and the PWM2_3 are input to the drive circuit D1 in the fifth power subunit 222, so as to control the turn-on or turn-off of the first power element Q1 and the second power element Q2 in the fifth power subunit 222. The second PWM signals PWM2_4 and the PWM2_5 are input to the drive circuit D1 in the sixth power subunit 223, so as to control the turn-on or turn-off of the first power element Q1 and the second power element Q2 in the sixth power subunit 223.

The motor control system 100 in the present application may be applied to mobile devices such as a UAV 200, a remote control vehicle and an unmanned surface vehicle. As an embodiment of the present application, the motor control system 100 is applied to the UAV 200. The UAV 200 may be a three-rotor, a four-rotor, a six-rotor or an eight-rotor UAV.

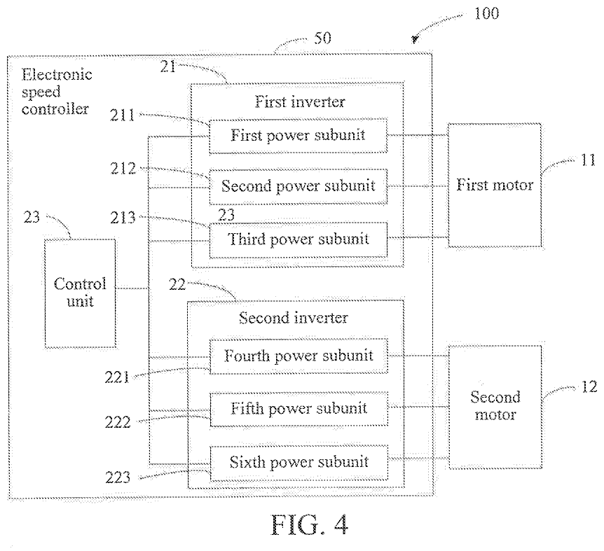

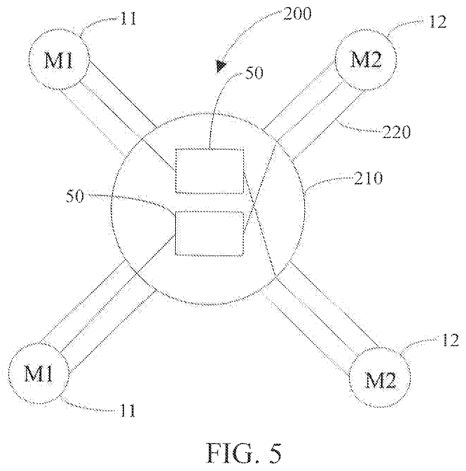

As shown in FIG. 4 and FIG. 5, the UAV 200 in the present application is a four-rotor UAV. The UAV includes a body 210, four arms 220 connected to the body 210 and an electronic speed controller 50 disposed on the body 210. In some implementations, the four arms 220 may be integrally formed with the body 210. In some other implementations, the four arms 220 and the body 210 may be independent components that are fixed together by screw locking, gluing or the like after being separately manufactured. The first motor 11 and the second motor 12 are disposed on the arm 220, and the first motor 11 and the second motor 12 are disposed diagonally relative to the body 210 of the UAV 200 (that is, the first motor 11 and the second motor 12 are respectively disposed on two arms 210 that are disposed diagonally). The control unit 23, the first inverter 21 electrically connected to the control unit 23 and the second inverter 22 electrically connected to the control unit 23 are integrated in one electronic speed controller 50. It can be understood that other two diagonally disposed motors may also be controlled by adopting the integrated electronic speed controller 50 in the embodiments of the present application. This design has the advantages: When the UAV 200 is in flight, one electronic speed controller 50 is damaged, and the other electronic speed controller 50 can control the motor located diagonally to continue running, so that the UAV 200 can land smoothly. If one electronic speed controller 50 controls two motors located on the same side, and either of the two electronic speed controllers 50 is damaged, the UAV 200 may roll over and crash. Controlling the motor located diagonally by using the same electronic speed controller 50 can help reduce the volume of a circuit board of the electronic speed controller in the UAV, thereby meeting a miniaturization design requirement of the UAV, and improving the endurance of the UAV.

Finally, it should be noted that the foregoing embodiments are merely intended for describing the technical solutions of the present application, but not for limiting the present application. Under the idea of the present application, the technical features in the foregoing embodiments or different embodiments may also be combined, the steps may be implemented in any order and there are many other variations of different aspects of the present application, which are not provided in detail for brevity. Although the present application is described in detail with reference to the foregoing embodiments, persons of ordinary skill in the art should understand that they may still make modifications to the technical solutions described in the foregoing embodiments or make equivalent replacements to some technical features thereof, and such modifications or replacements do not cause the essence of corresponding technical solutions to depart from the scope of the technical solutions of the embodiments of the present application.

What is claimed is:

1. A motor control system, comprising a control unit, a first inverter electrically connected to the control unit, a second inverter electrically connected to the control unit, a first motor electrically connected to the first inverter and a second motor electrically connected to the second inverter, the first inverter being connected in parallel to the second inverter;
wherein the control unit is configured to output a control signal to the first inverter and the second inverter and to respectively control, by using an alternating signal output by the first inverter and the second inverter, a running state of the first motor and second motor that are electrically connected thereto.

2. The motor control system according to claim 1, wherein the first inverter comprises at least one first power unit electrically connected to the first motor, the control unit is electrically connected to the at least one first power unit, and the control unit outputs the control signal to the at least one first power unit and controls the running state of the first motor by using an alternating signal output by the first power unit; and
wherein the second inverter comprises at least one second power unit electrically connected to the second motor, the control unit is electrically connected to the at least one second power unit, and the control unit outputs the control signal to the at least one second power unit and controls the running state of the second motor by using an alternating signal output by the second power unit.

3. The motor control system according to claim 2, wherein the first power unit comprises a first power subunit, a second power subunit and a third power subunit that are connected in parallel to each other, and the second power unit comprises a fourth power subunit, a fifth power subunit and a sixth power subunit that are connected in parallel to each other.

4. The motor control system according to claim 2, wherein both the first power unit and the second power unit comprise a drive circuit configured to receive the control signal, a first power element electrically connected to the drive circuit and a second power element electrically connected to the drive circuit, the first power element being connected in series to the second power element.

5. The motor control system according to claim 4, wherein both the first power element and the second power element are MOS transistors.

6. The motor control system according to claim 1, wherein the motor control system further comprises a first sampling circuit configured to acquire a three-phase voltage of the first motor and a second sampling circuit configured to acquire a three-phase voltage of the second motor;
wherein the first sampling circuit is electrically connected between the first inverter and the first motor, and the second sampling circuit is electrically connected between the second inverter and the second motor.

7. The motor control system according to claim 6, wherein the first sampling circuit comprises a first sampling resistor and a first operational amplifier circuit connected in parallel to the first sampling resistor,
wherein the second sampling circuit comprises a second sampling resistor and a second operational amplifier circuit connected in parallel to the second sampling resistor.

8. The motor control system according to claim 1, wherein the control unit is an MCU.

9. An unmanned aerial vehicle, comprising:
a body;
an arm connected to the body;
a control unit;
a first inverter electrically connected to the control unit;
a second inverter electrically connected to the control unit;
a first motor electrically connected to the first inverter; and
a second motor electrically connected to the second inverter, the first inverter being connected in parallel to the second inverter, the first motor and the second motor being disposed on the arm;
wherein the control unit is configured to output a control signal to the first inverter and the second inverter and to respectively control, by using an alternating signal output by the first inverter and the second inverter, a running state of the first motor and second motor that are electrically connected thereto.

10. The unmanned aerial vehicle according to claim 9, wherein the first motor and the second motor are disposed diagonally.
